(19) United States
(12) Patent Application Publication
(10) Pub. No.: US 2019/0324309 A1
(43) Pub. Date: Oct. 24, 2019

(54) TOUCH-PANEL-EQUIPPED DISPLAY DEVICE

(71) Applicant: SHARP KABUSHIKI KAISHA, Sakai City, Osaka (JP)

(72) Inventors: MASAKATSU TOMINAGA, Sakai City (JP); YOSHIHITO HARA, Sakai City (JP); MASAHIRO YOSHIDA, Sakai City (JP)

(21) Appl. No.: 16/314,617

(22) PCT Filed: Jul. 4, 2017
(86) PCT No.: PCT/JP2017/024432

§ 371 Date: Dec. 31, 2018

(30) Foreign Application Priority Data
Jul. 6, 2016 (JP) 2016-134182

(51) Int. Cl. G02F 1/1333; G02F 1/1368; G02F 1/1362; G02F 1/1343; G06F 3/044

(52) U.S. Cl. CPC G02F 1/13338; G02F 1/1368; G02F 1/136209; G02F 1/136286; G02F 1/133514; G06F 3/0446; G02F 2001/13685; G02F 1/136227; G02F 2001/136222; G02F 1/134363

(57) ABSTRACT

A touch-panel-equipped display device includes an active matrix substrate 1, a counter substrate, and a liquid crystal layer provided between the active matrix substrate 1 and the counter substrate, and has a touch surface on the active matrix substrate 1 side. The active matrix substrate 1 includes a substrate 100, and on the liquid crystal layer side of the substrate 100, a plurality of pixel electrodes 25, a common electrode 26, a plurality of touch detection electrodes 23 for detecting touch with respect to a touch surface, and a plurality of signal lines 24 respectively connected with the touch detection electrodes 23. The pixel electrodes 25, the common electrode 26, and the touch detection electrodes 23 are arranged so as to overlap with one another when viewed in a plan view, and the touch detection electrodes 23 are provided at positions closer to the substrate 100, as compared with pixel electrodes 25 and the common electrode 26.

### TECHNICAL FIELD

The present invention relates to a touch-panel-equipped display device.

### BACKGROUND ART

JP-A-2015-122057 discloses a touch screen panel integrated display device that includes a panel that serves as both of a display and a touch screen. On the panel, a plurality of pixels are formed, and each pixel is provided with a pixel electrode, and a transistor connected to the pixel electrode. Further, on the panel, a plurality of electrodes are arranged with spaces therebetween, so as to be opposed to the pixel electrodes. The plurality of electrodes function as common electrodes that form lateral electric fields (horizontal electric fields) between the same and the pixel electrodes in the display driving mode, and function as touch electrodes that form electrostatic capacitors between the same and a finger or the like in the touch driving mode. At least one signal line, approximately parallel with data lines, is connected to each of the plurality of electrodes, so that a touch driving signal or a common voltage signal is supplied thereto via the signal line.

### SUMMARY OF THE INVENTION

In a case where a plurality of electrodes arranged so as to be opposed to pixels electrodes have both of functions as the common electrodes and the touch electrodes, as is the case with JP-A-2015-122057, the electrodes as common electrodes have different potentials depending on respective time constants of the signal lines, in some cases. In this case, even if the same voltage signal is supplied to each data line, voltages that are applied to a liquid crystal layer at respective segments in each of which a plurality of electrodes are provided are different, and a luminance difference occurs among the segments. Besides, since the plurality of electrodes are used as common electrodes and touch electrodes, the writing of image data and the detection of a touch position have to be performed separately during one vertical period. Accordingly, as the number of the pixels increases, it is more likely that the image data writing time and the touch position detection time are insufficient.

It is an object of the present invention to provide a touch-panel-equipped display device that is able to have improved display quality and improved touch position detection accuracy.

A touch-panel-equipped display device of one embodiment in the present invention is a touch-panel-equipped display device that includes an active matrix substrate, a counter substrate provided so as to be opposed to the active matrix substrate, and a liquid crystal layer provided between the active matrix substrate and the counter substrate, and that has a touch surface on a side of the active matrix substrate. The active matrix substrate includes: a substrate; a plurality of pixel electrodes; a common electrode; a plurality of touch detection electrodes for detecting touch with respect to the touch surface; and a plurality of signal lines connected with the touch detection electrodes, respectively. The pixel electrodes, the common electrode, the touch detection electrodes, and the signal lines are provided on the liquid crystal layer side of the substrate. The pixel electrodes, the common electrode, and the touch detection electrodes are arranged so as to overlap with one another when viewed in a plan view, and the touch detection electrodes are provided at positions closer to the substrate, as compared with the pixel electrodes and the common electrode.

With the present invention, display quality and touch position detection accuracy can be improved.

### BRIEF DESCRIPTION OF DRAWINGS

FIG. 1 is a cross-sectional view of a touch-panel-equipped display device in Embodiment 1.

FIG. 2 schematically illustrates a schematic configuration of an active matrix substrate illustrated in FIG. 1.

FIG. 3 schematically illustrates an exemplary arrangement of touch detection electrodes.

FIG. 4 is an enlarged schematic diagram illustrating a part of an area of the active matrix substrate illustrated in FIG. 1.

FIG. 5 is a schematic cross-sectional view of a TFT area of the active matrix substrate illustrated in FIG. 4.

FIG. 6 is a schematic cross-sectional view of a non-TFT area of the active matrix substrate illustrated in FIG. 4.

FIG. 7 is a schematic cross-sectional view of a counter substrate illustrated in FIG. 1.

FIG. 8A is a cross-sectional view illustrating a process of producing a TFT area and a non-TFT area of the active matrix substrate illustrated in FIG. 1, which is a cross-sectional view illustrating a step of forming a black matrix on a glass substrate.

FIG. 8B is a cross-sectional view illustrating a step of forming a touch detection electrode on the glass substrate illustrated in FIG. 8A.

FIG. 8C is a cross-sectional view illustrating a step of forming a first insulating film on the glass substrate illustrated in FIG. 8B.

FIG. 8D is a cross-sectional view illustrating a step of forming a signal line on the first insulating film illustrated in FIG. 8C.

FIG. 8E is a cross-sectional view illustrating a step of forming a color filter on the first insulating film illustrated in FIG. 8D.

FIG. 8F is a cross-sectional view illustrating a step of forming a second insulating film on the color filter illustrated in FIG. 8E.

FIG. 8G is a cross-sectional view illustrating a step of forming a source electrode, a drain electrode, and a data line on the second insulating film illustrated in FIG. 8F.

FIG. 8H is a cross-sectional view illustrating a step of forming a semiconductor film that overlaps with the source electrode and the drain electrode illustrated in FIG. 8G.

FIG. 8I is a cross-sectional view illustrating a step of forming a gate insulating film, subsequent to the state illustrated in FIG. 8H.

FIG. 8J is a cross-sectional view illustrating a step of forming a gate electrode on the gate insulating film illustrated in FIG. 8I.

FIG. 8K is a cross-sectional view illustrating a step of forming an organic insulating film, subsequent to the state illustrated in FIG. 8J.

FIG. 8L is a cross-sectional view illustrating a step of forming a common electrode on the organic insulating film illustrated in FIG. 8K.

FIG. 8M is a cross-sectional view illustrating a step of forming a contact hole passing through the gate insulating film, and a third insulating film, subsequent to the state illustrated in FIG. 8L.

FIG. 8N is a cross-sectional view illustrating a step of forming a pixel electrode on the third insulating film illustrated in FIG. 8M.

FIG. 9A is a cross-sectional view of a non-TFT area of an active matrix substrate in Embodiment 2.

FIG. 9B is a cross-sectional view of a counter substrate in Embodiment 2.

FIG. 10 is a cross-sectional view illustrating another exemplary configuration of the active matrix substrate in Embodiment 2.

FIG. 11A is a cross-sectional view of a TFT area in an active matrix substrate in Embodiment 3.

FIG. 11B is a cross-sectional view of a non-TFT area in an active matrix substrate in Embodiment 3.

FIG. 11C is a cross-sectional view of a counter substrate in Embodiment 3.

FIG. 12A is a schematic cross-sectional view of a TFT area in an active matrix substrate in Modification Example 5.

FIG. 128 is a schematic cross-sectional view of a non-TFT area in an active matrix substrate in Modification Example 5.

### MODE FOR CARRYING OUT THE INVENTION

A touch-panel-equipped display device of one embodiment in the present invention is a touch-panel-equipped display device that includes an active matrix substrate, a counter substrate provided so as to be opposed to the active matrix substrate, and a liquid crystal layer provided between the active matrix substrate and the counter substrate, and that has a touch surface on a side of the active matrix substrate. The active matrix substrate includes: a substrate; a plurality of pixel electrodes; a common electrode; a plurality of touch detection electrodes for detecting touch with respect to the touch surface; and a plurality of signal lines connected with the touch detection electrodes, respectively. The pixel electrodes, the common electrode, the touch detection electrodes, and the signal lines are provided on the liquid crystal layer side of the substrate. The pixel electrodes, the common electrode, and the touch detection electrodes are arranged so as to overlap with one another when viewed in a plan view, and the touch detection electrodes are provided at positions closer to the substrate, as compared with the pixel electrodes and the common electrode (the first configuration).

According to the first configuration, the touch-panel-equipped display device has a touch surface on the active matrix substrate side, and a plurality of pixel electrodes, a common electrode, a plurality of touch detection electrode, and signal lines are provided on the liquid crystal layer side of the active matrix substrate. The common electrode and the touch detection electrodes are provided independently from each other. The common electrode is used for displaying an image, and the touch detection electrodes detect touch with respect to the touch surface. With this configuration, the potential of the common electrode 26 does not change due to differences in the time constants of the signal lines 24, and it is unlikely that differences in voltage applied to the liquid crystal layer would occur. Further, since the common electrode and the touch detection electrodes are provided independently, display control and touch detection control can be carried out in parallel. Therefore, even if the active matrix substrate has high definition, the display control time and the detection control time can be ensured, and decreases in the brightness of pixels or decreases in the detection sensitivity can be reduced.

Besides, the pixel electrodes, the common electrode, and the touch detection electrodes are arranged so as to overlap when viewed in a plan view. In other words, the display area and the detection area overlap. This allows the aperture ratio to be improved, as compared with a case where the pixel electrodes, the common electrode, and the touch detection electrodes do not overlap. Further, the touch detection electrodes are arranged at positions closer to the substrate, as compared with the pixel electrodes and the common electrode. In other words, the pixel electrodes or the common electrode are not arranged in the range from the substrate to the touch detection electrodes, whereby the touch detection accuracy can be improved.

In the first configuration, the active matrix substrate may further include a light-shielding part between the pixel electrodes and the substrate (the second configuration).

With the second configuration, external light from a surface of the substrate on a side opposite to the liquid crystal layer side can be blocked.

In the second configuration, the light-shielding part may be made of a resin in black color (the third configuration).

With the third configuration, leakage current due to the touch detection electrodes can be reduced, as compared with a case where a metal material is used for forming the light-shielding part.

In the second or third configuration, the light-shielding part may be provided at a position that does not overlap with the pixel electrodes (the fourth configuration).

With the fourth configuration, the light-shielding part does not overlap with the pixel electrodes, whereby the aperture ratio of the pixels can be improved.

In any one of the second to fourth configurations, the light-shielding part may be provided at a position that does not overlap with the touch detection electrodes (the fifth configuration).

With the fifth configuration, decreases in the touch detection accuracy can be reduced, as compared with a case where the light-shielding part overlaps with the touch detection electrodes.

In any one of the first to fifth configurations, the active matrix substrate further includes a color filter that is provided at a position overlapping with the pixel electrodes (the sixth configuration).

With the sixth configuration, as compared with a case where a color filter is provided on the counter substrate, it is unnecessary to adjust the sizes of the pixel electrodes or the like, while considering displacement between the active matrix substrate and the counter substrate occurring when these are bonded with each other, and a desired aperture ratio can be ensured.

In any one of the first to fifth configurations, the counter substrate may further include a color filter that is provided at a position overlapping with the pixel electrodes (the seventh configuration).

In any one of the first to seventh configurations, the touch detection electrodes may be arranged so as to be in contact with the substrate; and the active matrix substrate may further include at least one insulating film between the touch detection electrodes and the common electrode, and at least one insulating film between the common electrode and the pixel electrodes (the eighth configuration).

According to the eighth configuration, the touch detection electrodes are provided in contact with the substrate, whereby the touch detection sensitivity can be improved.

In any one of the first to eighth configurations, the active matrix substrate may further include a plurality of gate lines, and a plurality of data lines; and the touch detection electrodes may be provided at positions closer to the substrate, as compared with the gate lines and the data lines (the ninth configuration).

With the ninth configuration, it is unlikely that capacitors would be formed between a user's finger or the like and the gate lines or the data lines, whereby decreases in the touch detection accuracy can be reduced, as compared with a case where the touch detection electrodes are arranged at positions farther from the substrate, than the positions of the gate lines or the data lines.

In any one of the first to ninth configurations, the signal lines and the touch detection electrodes may be provided in different layers (the tenth configuration).

With the tenth configuration, short-circuiting between the signal lines and other touch detection electrodes to which the foregoing signal lines are not connected can be prevented.

In any one of the first to ninth configurations, the signal lines and the touch detection electrodes may be provided in the same layer; and the active matrix substrate may further include at least one insulating film between the substrate and the touch detection electrodes, at least one insulating film between the touch detection electrodes and the common electrode, and at least one insulating film between the common electrode and the pixel electrodes (the eleventh configuration).

With the eleventh configuration, a step of forming contact holes for connecting the signal lines and the touch detection electrodes can be omitted.

In any one of the first to eleventh configuration, the active matrix substrate may further include a plurality of switching elements each of which includes a source electrode, a drain electrode, a semiconductor film, and a gate electrode; and the gate electrode may be provided on a side of the liquid crystal layer, with respect to the semiconductor film (the twelfth configuration).

According to the twelfth configuration, the gate electrodes are provided on the liquid crystal layer side with respect to the semiconductor film. Accordingly, light from the counter substrate side that would be incident on the channel areas of the switching elements can be blocked.

In any one of the first to eleventh configurations, the active matrix substrate may further include a plurality of switching elements each of which includes a source electrode, a drain electrode, a semiconductor film, and a gate electrode; and the gate electrode may be provided on a side of the substrate, with respect to the semiconductor film (the thirteenth configuration).

According to the thirteenth configuration, the gate electrodes are provided on the substrate side with respect to the semiconductor films. Accordingly, light from the substrate side that would be incident on the channel areas of the switching elements can be blocked.

In any one of the first to thirteenth configurations, the counter substrate may further include a transparent electrode layer on a surface of the counter substrate on a side opposite to the liquid crystal layer so that the transparent electrode layer overlaps with the pixel electrodes (the fourteenth configuration).

According to the fourteenth configuration, the transparent electrode layer is provided on the counter substrate, whereby alignment defects in the liquid crystal layer due to external electric fields from the counter substrate side can be reduced.

### Embodiment 1

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

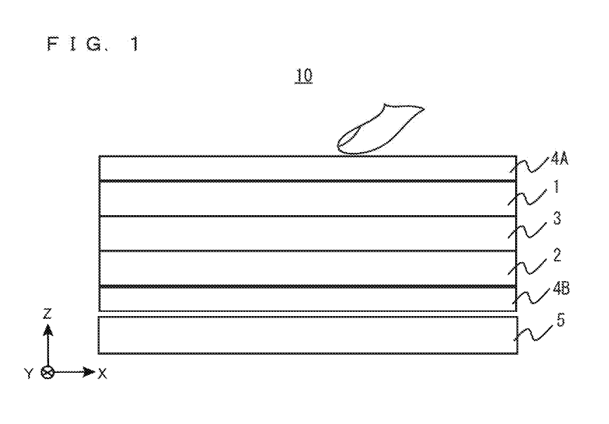

FIG. 1 is a cross-sectional view of a touch-panel-equipped display device 10 in the present embodiment. The touch-panel-equipped display device 10 in the present embodiment includes an active matrix substrate 1, a counter substrate 2, a liquid crystal layer 3 interposed between the active matrix substrate 1 and the counter substrate 2, a pair of polarizing plates 4A. 4B, and a backlight 5.

The touch-panel-equipped display device 10 has a function of displaying an image, and has a function of detecting a position at which a finger of a user or the like touches (touch position) on the displayed image, that is, on a touch surface on the polarizing plate 4A on the active matrix substrate 1 side.

This touch-panel-equipped display device 10 is a so-called in-cell type touch panel display device in which elements necessary for detecting a touch position are provided in the active matrix substrate 1. Further, in the touch-panel-equipped display device 10, the method for driving liquid crystal molecules included in the liquid crystal layer 3 is the horizontal electric field driving method. To realize the horizontal electric field driving method, pixel electrodes and a common electrode for forming electric fields are formed on the active matrix substrate 1.

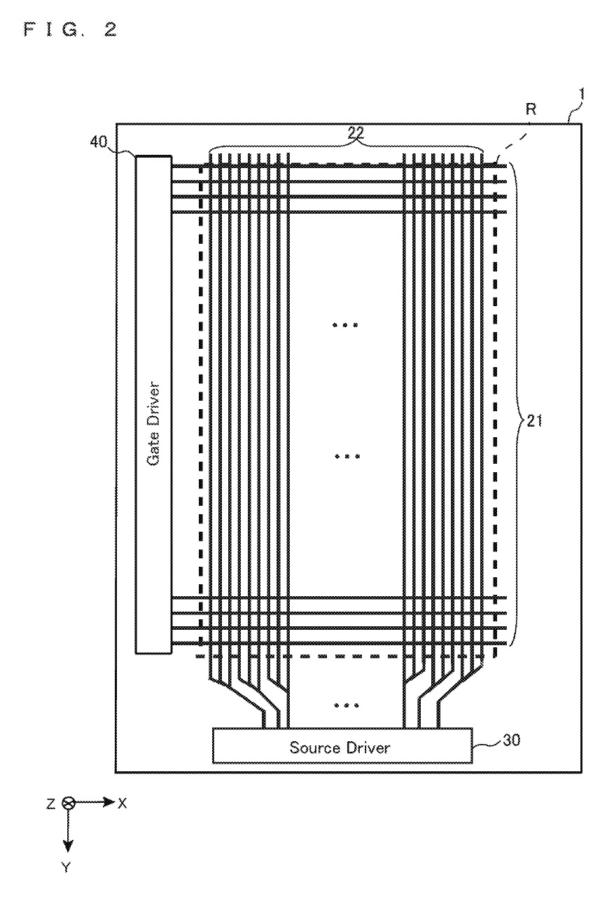

FIG. 2 schematically illustrates a schematic configuration of the active matrix substrate 1. The active matrix substrate 1 includes a plurality of gate lines 21 and a plurality of data lines 22 on its surface on the liquid crystal layer 3 side. The active matrix substrate 1 includes a plurality of pixels defined by the gate lines 21 and the data lines 22, and an area where the pixels are formed is a display area R of the active matrix substrate 1.

In each pixel, a pixel electrode and a switching element are arranged. For forming the switching element, for example, a thin film transistor is used.

The active matrix substrate 1 includes a source driver 30 and a gate driver 40 in an area (frame area) outside the display area R. The source driver 30 is connected with each data line 22, and supplies voltage signals to the data lines 22 in accordance with image data, respectively. The gate driver 40 is connected with each gate line 21, and sequentially supplies a voltage signal to the gate lines 21 so as to scan the gate lines 21.

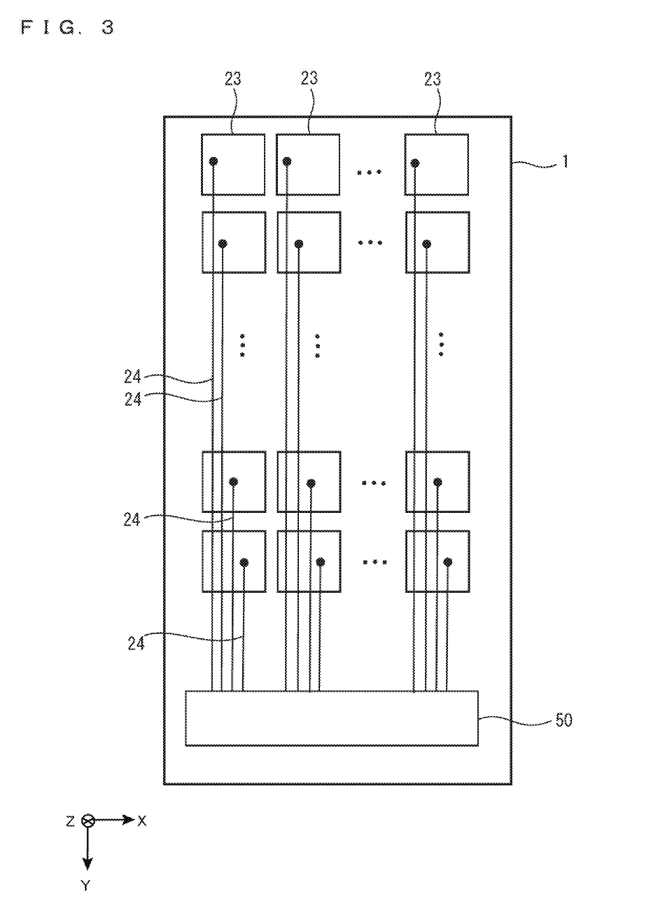

FIG. 3 schematically illustrates an exemplary arrangement of touch detection electrodes for detecting a touch position. The touch detection electrode 23 are formed on a liquid crystal layer 3 side surface of the active matrix substrate 1. As illustrated in FIG. 3, the touch detection electrode 23 is in a rectangular shape, and a plurality of the same are arranged in matrix on the active matrix substrate 1. The touch detection electrode 23 is, for example, in an approximately square shape whose side is several millimeters.

The active matrix substrate 1 is further provided with a controller 50. The controller 50 performs a controlling operation for detecting a touch position.

The controller 50 and the touch detection electrodes 23 are connected by signal lines 24 extending in the Y axis direction. In other words, the same number of signal lines 24 as the number of the touch detection electrodes 23 are formed on the active matrix substrate 1.

The touch detection electrode 23 has a parasitic capacitor formed between the same and adjacent one of the touch detection electrodes 23, etc., and when a human finger or the like touches the display surface, a capacitor is formed between the touch detection electrode 23 and the human finger or the like, which causes an electrostatic capacitance to increase. In touch position detection control, the controller 50 supplies a touch driving signal to the touch detection electrodes 23 via the signal lines 24, and receives a touch detection signal via the signal lines 24. By doing so, the controller 50 detects changes in electrostatic capacitances at respective positions of the touch detection electrodes 23, thereby detecting a touch position. In other words, the signal lines 24 function as lines for transmission/reception of the touch driving signal and the touch detection signal.

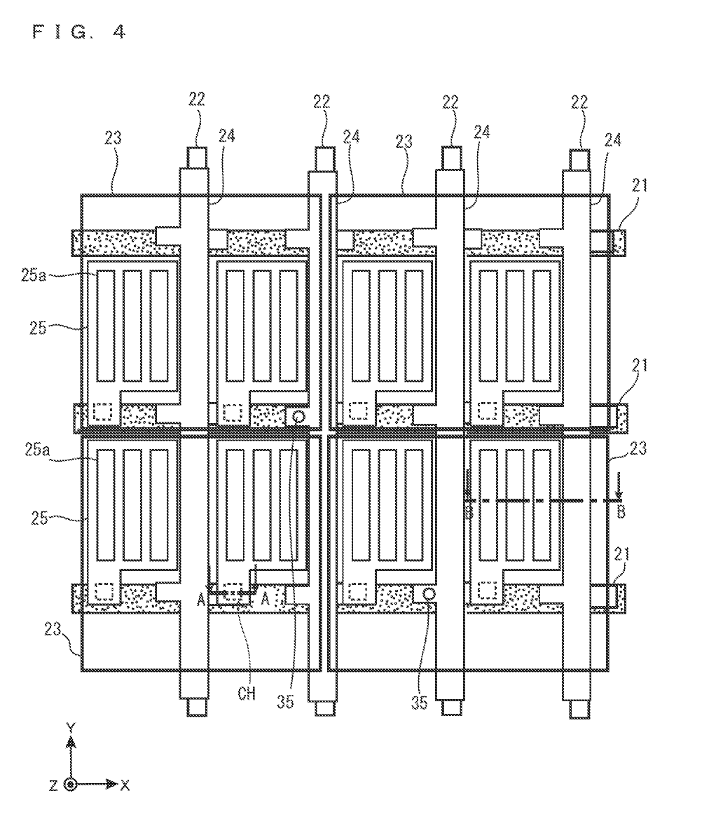

FIG. 4 is an enlarged schematic diagram illustrating a part of the area of the active matrix substrate 1. As illustrated in FIG. 4, a plurality of pixel electrodes 25 are arranged in matrix. Further, though the illustration is omitted in FIG. 4, thin film transistors (TFTs) as switching elements are also arranged in matrix in correspondence to the pixel electrodes 25, respectively.

The pixel electrodes 25 are provided in the areas defined by the gate lines 21 and the source lines 22, respectively. The gate electrode of each TFT described above is connected with the gate line 21, either the source electrode or the drain electrode thereof is connected with the data line 22, and the other one is connected with the pixel electrode 25.

Further, though the illustration is omitted in FIG. 4, the common electrode is arranged over an entirety of the display area. The touch detection electrodes 23, the pixel electrodes 25, and the common electrode are arranged so as to overlap with one another when viewed in a plan view.

As illustrated in FIG. 4, the signal lines 24 extending in the Y axis direction are arranged so as to partially overlap, in the normal line direction of the active matrix substrate 1, with the data lines 22 extending in the Y axis direction. More specifically, the signal lines 24 are provided on a side in the Z axis positive direction with respect to the data lines 22, and the signal lines 24 and the data lines 22 partially overlap with each other when viewed in a plan view.

In FIG. 4, white circles 35 indicate portions at which the touch detection electrodes 23 and the signal line 24 are connected with each other.

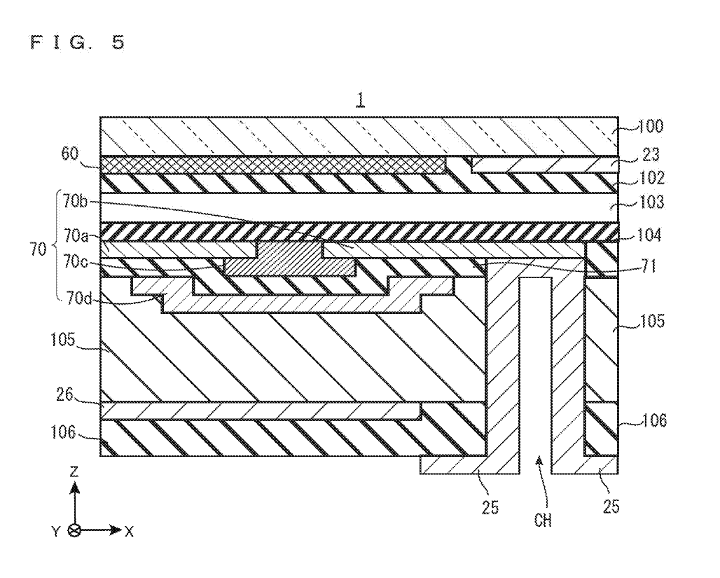

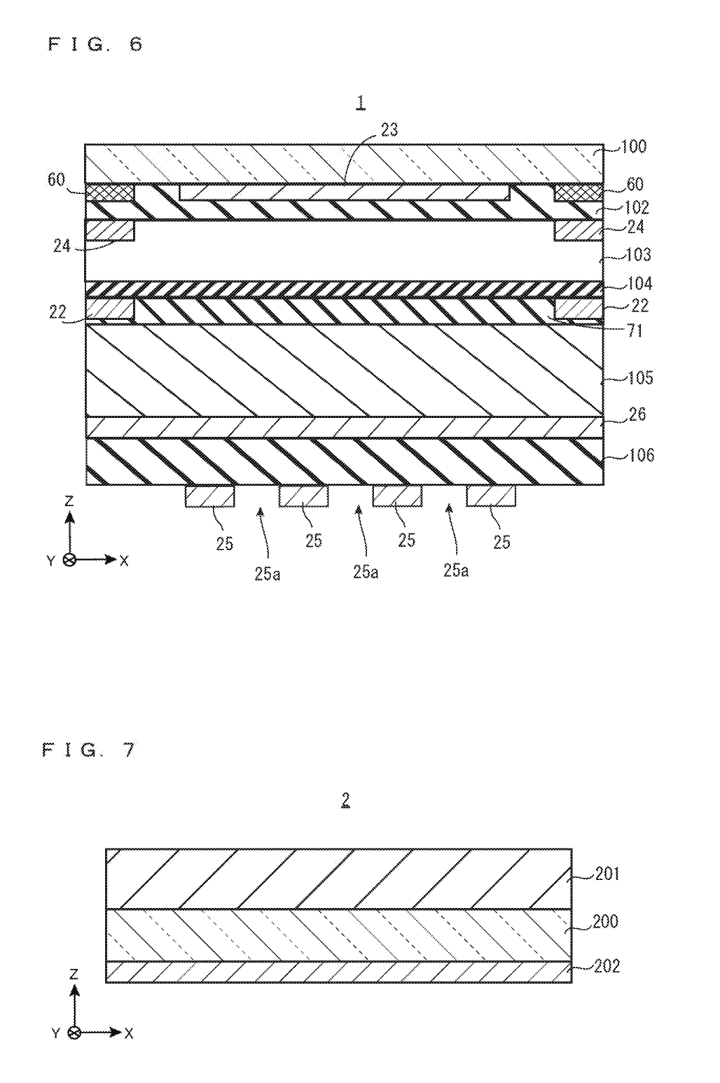

FIG. 5 illustrates an A-A cross section of the active matrix substrate 1 illustrated in FIG. 4, that is, it is a schematic cross-sectional view of an area thereof where the TFT is arranged (TFT area). FIG. 6 illustrates a B-B cross section of the active matrix substrate 1 illustrated in FIG. 4, that is, it is a schematic cross-sectional view of an area thereof where no TFT is arranged (non-TFT area).

As illustrated in FIGS. 5 and 6, on one of the surfaces of the glass substrate 100, touch detection electrodes 23 and a black matrix 60 are arranged. The black matrix 60 is arranged so as to be separated from the touch detection electrodes 23, as illustrated in FIGS. 5, 6. The black matrix 60 is preferably made of a material having a low reflectance so as to reduce decreases in contrast due to reflection of external light (glare), and changes in properties of the TFT due to internal reflection of backlight light. Further, to reduce leakage current of an adjacent touch detection electrode 23, the black matrix 60 preferably has a resistance higher than that of the semiconductor films of the TFTs. For example, in a case where the semiconductor film is an amorphous silicon film, a photosensitive resin such as a photoresist having a volume specific resistance of 10¹⁰ to 10¹⁴ Ω·cm and being colored in black is preferably used. The black matrix 60 and the touch detection electrodes 23, however, do not necessarily be separated; for example, if the black matrix 60 has a resistance sufficiently higher than that of the semiconductor film, the touch detection electrodes 23 and the black matrix 60 may be brought into contact or be superposed on each other.

The touch detection electrodes 23 are transparent electrodes, and are made of a material such as ITO (In-Tin-O), ZnO (Zn—O), IZO (In—Zn—O), IGZO (In-Ga—Zn-O), or ITZO (In-Tin-Zn—O).

Further, as illustrated in FIGS. 5 and 6, on one of the surfaces of the glass substrate 100, a first insulating film 102 is arranged so as to cover the black matrix 60 and the touch detection electrodes 23. The first insulating film 102 is made of, for example, silicon nitride (SiNₓ) or silicon dioxide (SiO₂).

Still further, as illustrated in FIG. 6, on the surface of the first insulating film 102, the signal lines 24 are arranged so as to overlap with the black matrix 60. The signal lines 24 are made of, for example, any one of copper (Cu), titanium (Ti), molybdenum (Mo), aluminum (Al), magnesium (Mg), cobalt (Co), chromium (Cr), tungsten (W), or a mixture of these.

As illustrated in FIGS. 5 and 6, a color filter 103 is arranged so as to cover the first insulating film 102 and the signal lines 24. The color filter 103 is composed of coloring members that are colored in red (R), green (G), and blue (B).

On the surface of the color filter 103, a second insulating film 104 is formed. The second insulating film 104 is made of, for example silicon nitride (SiNₓ) or silicon dioxide (SiO₂).

As illustrated in FIG. 5, in the TFT area, TFTs 70 are formed on the surface of the second insulating film 104. The TFT 70 includes a source electrode 70a, a drain electrode 70b, a semiconductor film 70c, and a gate electrode 70d.

As illustrated in FIG. 5, the source electrode 70a and the drain electrode 70b are arranged in contact with the second insulating film 104. Further, as illustrated in FIG. 6, in the non-TFT area, the data lines 22 are arranged on the surface of the second insulating film 104. The source electrode 70a, the drain electrode 70b, and the data line 22 are formed with, for example, a laminate film of titanium (Ti) and copper (Cu).

As illustrated in FIG. 5, the semiconductor film 70c is arranged so as to partially overlap with the source electrode 70a and the drain electrode 70b. The semiconductor film 70c is, for example, an oxide semiconductor film, and may contain at least one metal element among In, Ga, and Zn. In the present embodiment, the semiconductor film 70c contains, for example, In—Ga—Zn—O-based semiconductor. Here, the In—Ga—Zn—O-based semiconductor is a ternary oxide of indium (In), gallium (Ga), and zinc (Zn), in which the ratio (composition ratio) of In, Ga, and Zn is not limited particularly, and examples of the ratio include In:Ga:Zn=2:2:1, In:Ga:Zn=1:1:1, and In:Ga:Zn=1:1:2.

As illustrated in FIGS. 5 and 6, a gate insulating film 71 is formed so as to overlap with the source electrode 70a, the drain electrode 70b, and the semiconductor film 70c in the TFT area, and to overlap with the data lines 22 in the non-TFT area. The gate insulating film 71 is made of, for example, silicon nitride (SiNₓ) or silicon dioxide (SiO₂).

In the TFT area, the gate electrode 70d is formed so as to overlap with the gate insulating film 71. The gate electrode 70d is arranged on a side lower with respect to the semiconductor film 70c (on the side in the Z-axis negative direction), that is, on the liquid crystal layer 3 side. The gate electrode 70d is formed with, for example, a laminate film of titanium (Ti) and copper (Cu).

As illustrated in FIGS. 5 and 6, in the TFT area and the non-TFT area, an organic insulating film (flattening film) 105 is arranged so as to cover the gate electrode 70d and the gate insulating film 71. The organic insulating film 105 is made of, for example, acryl-based organic resin material such as polymethyl methacrylate resin (PMMA).

Further, in the TFT area and the non-TFT area, a common electrode 26 is arranged on the surface of the organic insulating film 105. Then, a third insulating film 106 is arranged so as to cover the common electrode 26. The common electrode 26 is a transparent electrode, and is made of a material of, for example, ITO, ZnO, IZO, IGZO, ITZO or the like. The third insulating film 106 is made of, for example, silicon nitride (SiNₓ) or silicon dioxide (SiO₂).

As illustrated in FIGS. 5 and 6, in the TFT area, a contact hole CH passing through the gate insulating film 71, the organic insulating film 105, and the third insulating film 106 is provided. On the surface of the third insulating film 106, the pixel electrode 25 is arranged. The pixel electrode 25 is in contact with the drain electrode 70b through the contact hole CH. In the pixel electrode 25, slits 25a are formed.

Next, the following description describes a configuration of the counter substrate 2. FIG. 7 is a schematic cross-sectional view of the counter substrate 2. As illustrated in FIG. 7, in the counter substrate 2, an overcoat layer 201 is arranged so as to cover one of surfaces of a glass substrate 200, that is, the surface thereof on the liquid crystal layer 3 (see FIG. 1) side (on the side in the Z-axis positive direction). Further, a shield electrode 202 is provided so as to cover the other surface of the glass substrate 200, that is, the surface thereof on the polarizing plate 4B (see FIG. 1) side (on the side in the Z-axis negative direction). The shield electrode 202 is a transparent electrode film, and is made of a material of, for example, ITO. ZnO, IZO. IGZO, ITZO, or the like.

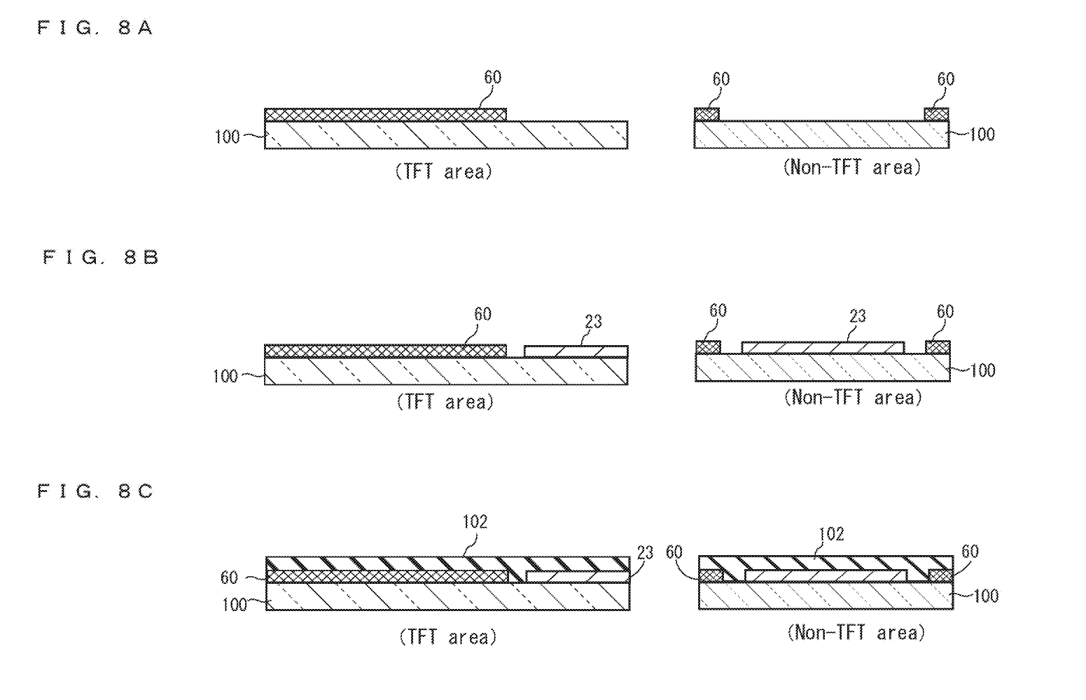

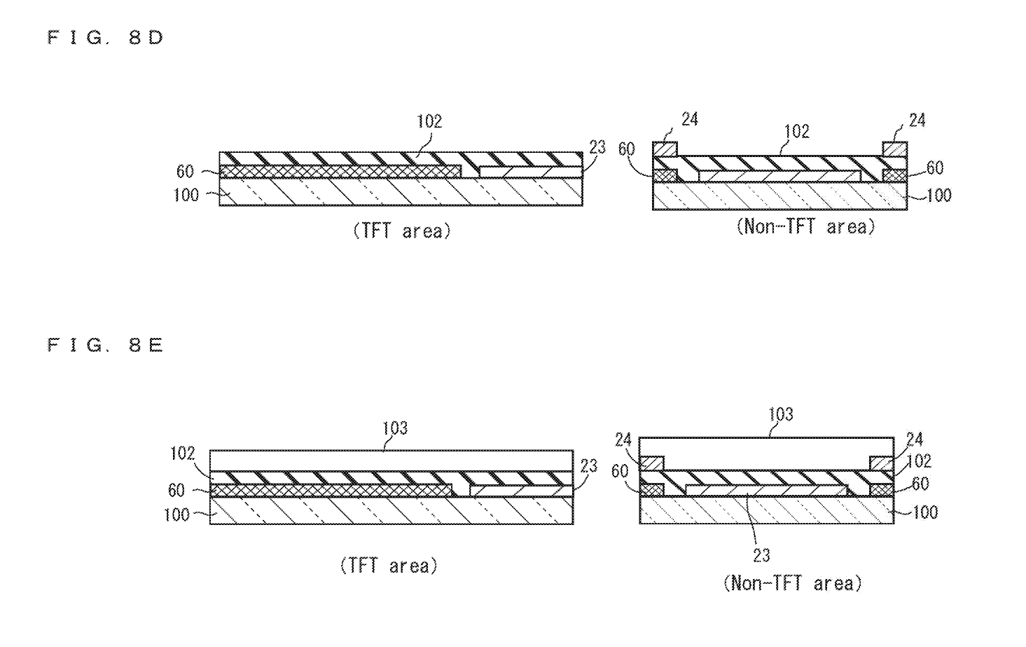

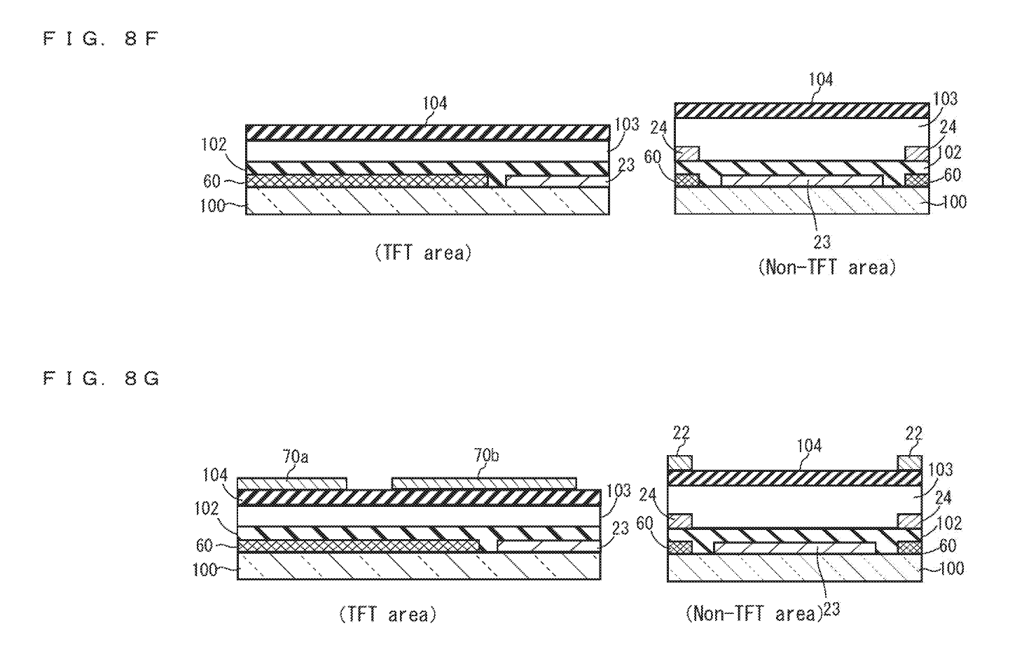

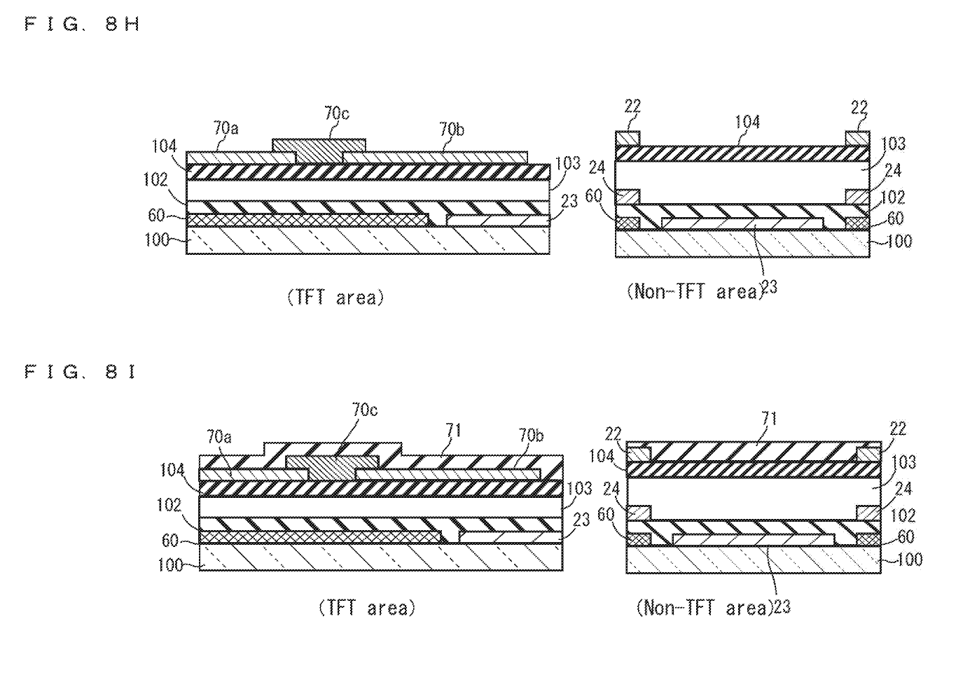

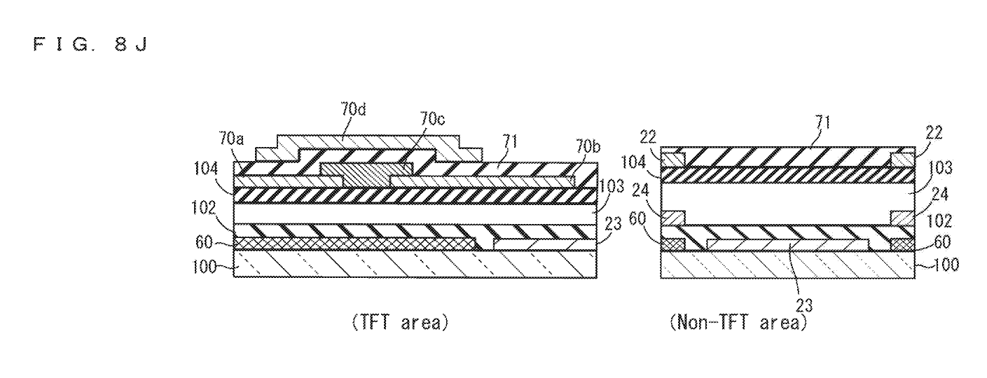

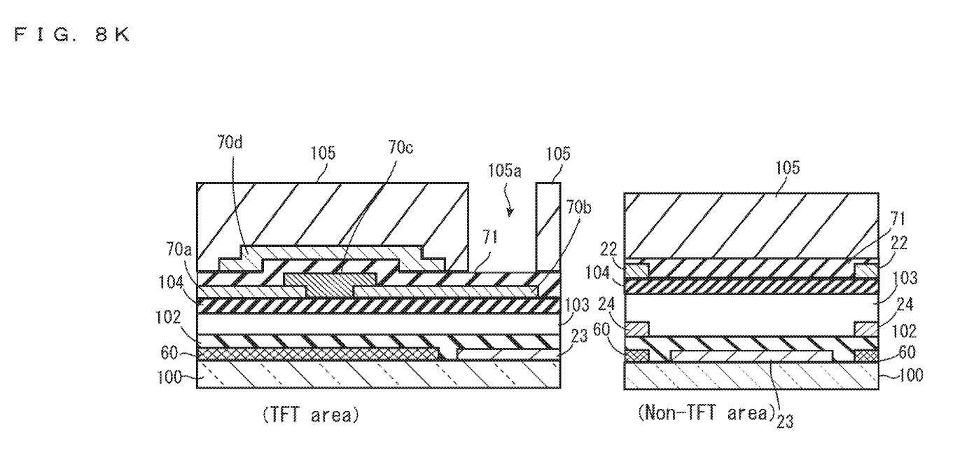

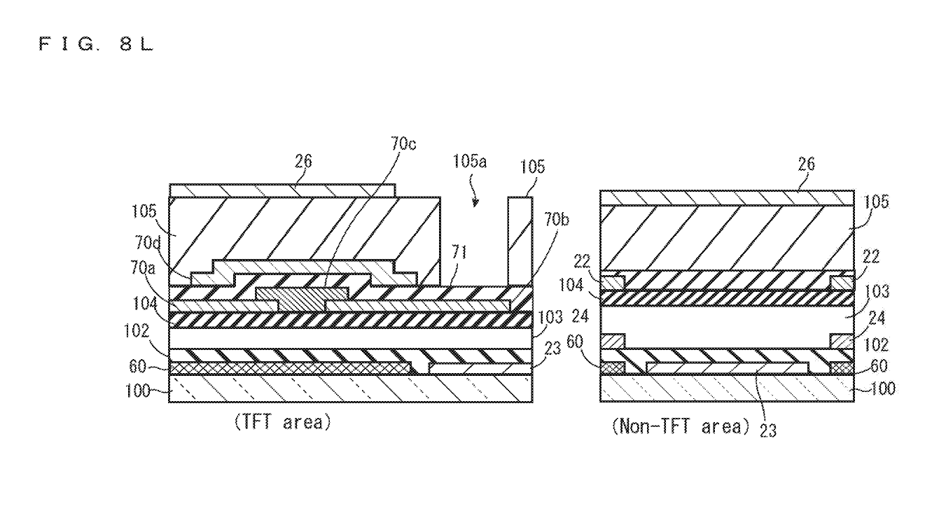

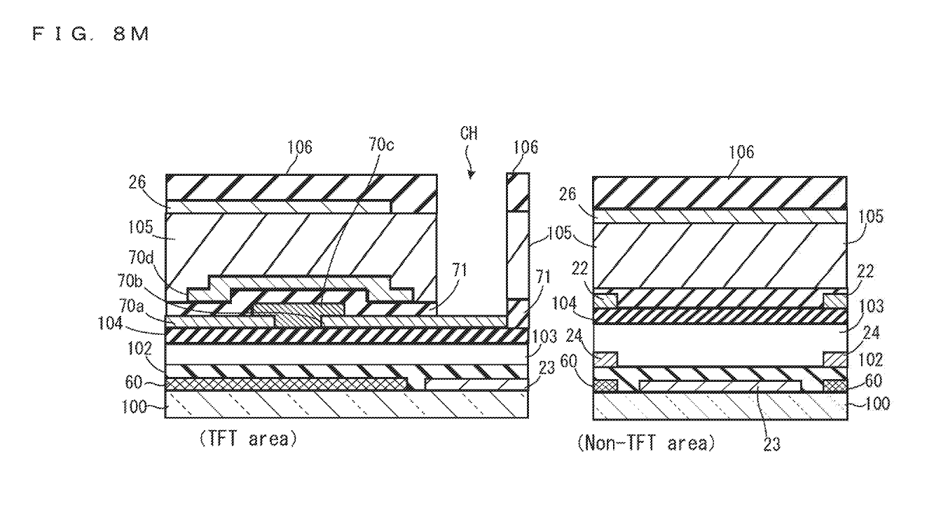

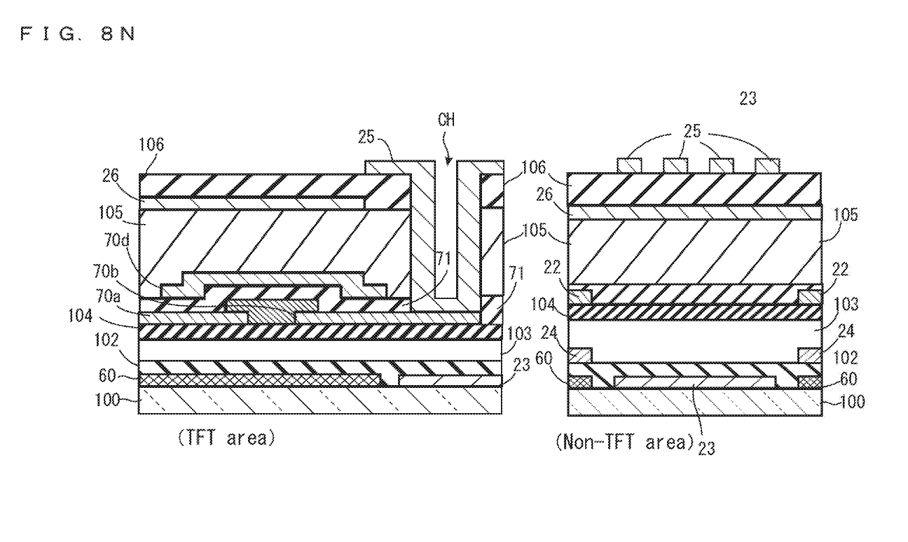

Next, the following description describes a method for producing the active matrix substrate 1. FIGS. 8A to 8N are cross-sectional views illustrating a process for producing the TFT area and the non-TFT area of the active matrix substrate 1. The following description describes the producing process while referring to FIGS. 8A to 8N.

First, a black resist is applied over one of the surfaces of the glass substrate 100, and is patterned by photolithography. Through this step, a black matrix 60 is formed in the TFT area and the non-TFT area (see FIG. 8A).

Next, a transparent electrode film is formed so as to cover the black matrix 60 on the glass substrate 100, and then, photolithography and wet etching are carried out so as to pattern the transparent electrode film. Through this step, the touch detection electrode 23 is formed at such a position that it does not overlap with the black matrix 60 (see FIG. 8B).

Subsequently, the first insulating film 102 made of, for example, silicon nitride (SiNₓ), is formed so as to cover black matrix 60 and touch detection electrode 23 on the glass substrate 100 (see FIG. 8C).

Then, a metal film made of, for example, copper (Cu), is formed on the first insulating film 102, and photolithography and wet etching are carried out so as to pattern the metal film. Through this step, in the non-TFT area, the signal line 24 is formed at a position overlapping with the black matrix 60 (see FIG. 8D).

Next, a color formation material is applied over the first insulating film 102, and then, pre-baking, photolithography, and post-baking are carried out so as to pattern the color formation material. This process is repeatedly carried out for color formation materials of three colors (R. G. B). Through this step, the color filter 103 of three colors (R, G. B) are formed in the TFT area and the non-TFT area (see FIG. 8E).

Subsequently, the second insulating film 104 made of, for example, silicon oxide (SiOₓ), is formed on the color filter 103, so as to cover the color filter 103 (see FIG. 8F).

Then, for example, films of titanium (Ti) and copper (Cu) are sequentially formed on the second insulating film 104, and then, photolithography and wet etching are carried out so as to pattern the laminate metal film of titanium (Ti) and copper (Cu). Through this step, the source electrode 70a and the drain electrode 70b are formed on the second insulating film 104 in the TFT area. Further, the data line 22 is formed at a position overlapping with the signal line 24, on the second insulating film 104 in the non-TFT area (see FIG. 8G).

Next, a semiconductor film containing, for example, In, Ga, Zn, O is formed on the second insulating film 104, so as to cover the source electrode 70a and the drain electrode 70b in the TFT area, and then, photolithography and wet etching are carried out so as to pattern the semiconductor film. Through this step, in the TFT area, the semiconductor film 70c is formed so as to partially overlap with the source electrode 70a and the drain electrode 70b (see FIG. 8H).

Subsequently, the gate insulating film 71 made of, for example, silicon oxide (SiOₓ) is formed so as to cover the source electrode 70a, the drain electrode 70b, and the semiconductor film 70c in the TFT area, and the data line 22 in the non-TFT area (see FIG. 8I).

Then, a laminate metal film obtained by sequentially laminating, for example, titanium (Ti) and copper (Cu) is formed on the gate insulating film 71, and then, photolithography and wet etching are carried out so as to pattern the laminate metal film. Through this step, the gate electrode 70d overlapping with the source electrode 70a, the drain electrode 70b, and the semiconductor film 70c in the TFT area is formed (see FIG. 8J).

Next, an organic insulating film is formed so as to cover the gate electrode 70d and the gate insulating film 71 in the TFT area and the gate insulating film 71 in the non-TFT area. Then, the organic insulating film is patterned by photolithography. Through this step, the organic insulating film 105 is formed that has an opening 105a at a position overlapping with the drain electrode 70b in the TFT area (see FIG. 8K).

Subsequently, a transparent electrode film made of, for example, ITO is formed on the organic insulating film 105, and then, photolithography and wet etching are carried out so as to pattern the transparent electrode film. Through this step, the common electrode 26 is formed on the organic insulating film 105 in the TFT area and the non-TFT area (see FIG. 8L).

A third insulating film made of, for example, silicon nitride (SiNₓ) is formed so as to cover the common electrode 26 and the organic insulating film 105 in the TFT area and the common electrode 26 in the non-TFT area. Then, photolithography and dry etching are carried out so as to pattern the third insulating film and the gate insulating film 71. Through this step, the contact hole CH passing through the gate insulating film 71 in the TFT area is formed. Further, the third insulating film 106 is formed in an area other than the contact hole CH (see FIG. 8M).

Next, a transparent electrode film made of, for example, ITO is formed so as to cover the third insulating film 106, and then, photolithography and wet etching are carried out so as to pattern the transparent electrode film. Through this step, the pixel electrode 25 is formed on the third insulating film 106 in the TFT area and the non-TFT area. The pixel electrode 25 is in contact with the drain electrode 70b in the TFT area, and includes slits 25a (see FIG. 8N).

In Embodiment 1 described above, the touch detection electrode 23 and the common electrode 26 are arranged independently from each other. The common electrode 26 is formed over an entirety of the display area on the active matrix substrate 1, and is not arranged in matrix, unlike the touch detection electrodes 23. With this configuration, the potential of the common electrode 26 does not change due to differences in the time constants of the signal lines 24, and differences in the voltages applied to the liquid crystal layer 3 are not large among the pixels, which makes it unlikely that display defects would occur.

Besides, since the touch detection electrodes 23 and the common electrode 26 are arranged independently from each other, the charging time for charging pixels for displaying an image and the detection time for touch detection do not have to be prepared separately, but these operations can be performed simultaneously, in one vertical period. Even with higher definition, therefore, the charging time and the detection time can be ensured, and decreases in the brightness or decreases in the detection sensitivity can be reduced.

Further, in Embodiment 1, in the active matrix substrate 1, the touch detection electrodes 23 and the pixel electrodes 25 are arranged so as to overlap with each other (see FIGS. 4 to 6). In other words, the display area and the detection area overlap with each other in the active matrix substrate 1, which allows the aperture ratio to be improved, as compared with a case where the detection area is provided separately from the display area.

Still further, the touch-panel-equipped display device 10 in Embodiment 1 has such a configuration that the active matrix substrate 1 side is to be touched. In other words, the liquid crystal layer, the color filter, and the like are not provided between a user's finger and the touch detection electrodes 23, which allows the detection sensitivity to be enhanced.

Still further, in Embodiment 1, the shield electrodes 202 are provided only on the counter substrate 2. In the horizontal electric field driving method, the shield electrodes are provided for the purpose of preventing alignment defects from occurring to the liquid crystal layer 3 due to external electric fields. In Embodiment 1, however, since the touch detection electrodes 23 are provided so as to be in contact with the glass substrate 100, and the touch detection electrodes 23 and the common electrode 26 function as shield electrodes, it is unnecessary to provide the shield electrodes in the active matrix substrate 1. In other words, since no shield electrode is provided on a substrate that is touched by a user's finger or the like, decreases in the detection accuracy can be reduced, as compared with a case where shield electrodes are provided. Further, as the shield electrodes 202 are provided on the counter substrate 2, alignment defects due to external electric fields from the counter substrate 2 side can be prevented from occurring to the liquid crystal layer 3. Particularly in a case where the touch-panel-equipped display device 10 is a thin type (for example, having a thickness of 0.3 to 0.6 mm), when the surface of the touch-panel-equipped display device 10 is touched, the touch-panel-equipped display device 10 is warped in some cases. Here, distances between members on the back side of the touch-panel-equipped display device 10 and the touch detection electrodes 23 change, whereby electrostatic capacitances of the touch detection electrodes 23 change, and the changes of the electrostatic capacitances cause the touch detection sensitivity to decrease. In Embodiment 1, as the shield electrodes 202 are provided on the counter substrate 2, the deflection of the touch-panel-equipped display device 10 is prevented, which makes it possible to reduce decreases in the touch detection sensitivity.

Further, in Embodiment 1, the TFT 70 provided on the active matrix substrate 1 has a top gate structure in which the gate electrode 70d is arranged on the liquid crystal layer 3 side with respect to the semiconductor film 70c. It is therefore unnecessary to additionally provide a light-shielding film for blocking light from the backlight 5 (see FIG. 1) in the channel area of the TFT 70. Incidentally, light incident on the active matrix substrate 1 from the side of a user is blocked by the black matrix 60 provided in the active matrix substrate 1.

Further, in Embodiment 1, by providing the color filter 103 in the active matrix substrate 1, parasitic capacitances generated between the touch detection electrodes 23 or the signal lines 24 and the gate lines 21 or the data line 22 can be reduced, and further, it is unlikely that the signal lines 24 and the data lines 22 would be short-circuited. Still further, as compared with a case where the color filter 103 is provided on the counter substrate 2, defects such as color mixing hardly occur due to the displacement occurring when the active matrix substrate 1 and the counter substrate 2 are bonded with each other. This makes it unnecessary to increase the size of the black matrix 60 or to decrease the size of the pixel electrode 25, considering displacement when the active matrix substrate 1 and the counter substrate 2 are bonded with each other. This allows a desired aperture ratio to be ensured.

Though the description of Embodiment 1 above principally describes the TFTs provided in the pixels, the gate driver 40 is also formed with a plurality of TFTs. These TFTs have a structure identical to the TFTs 70 provided in the pixels.

### Embodiment 2

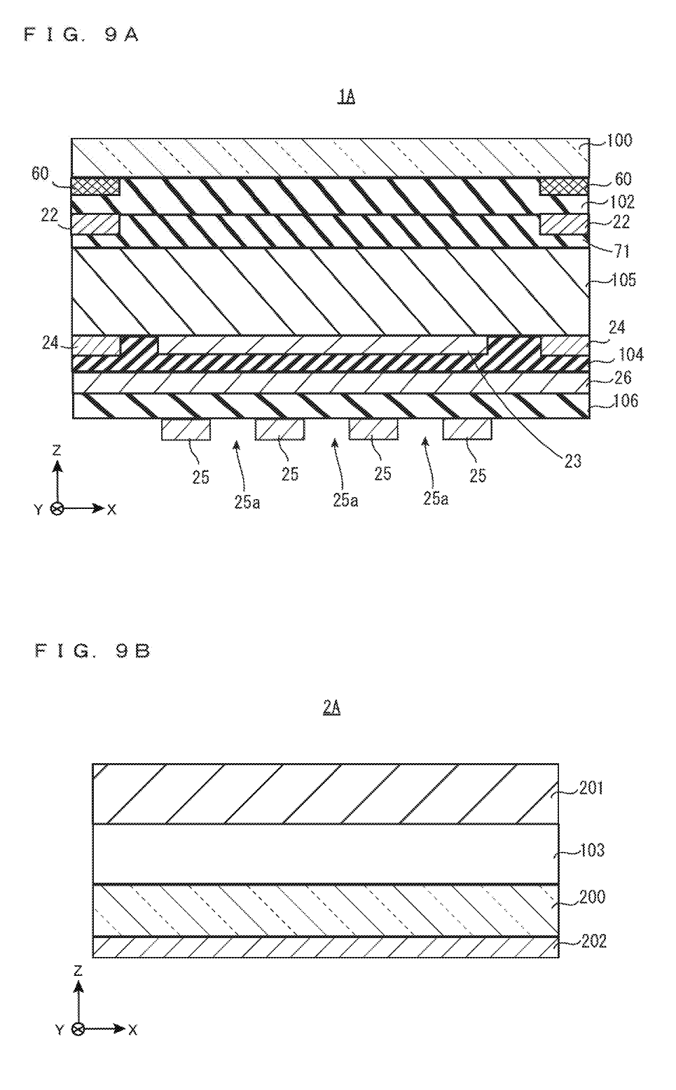

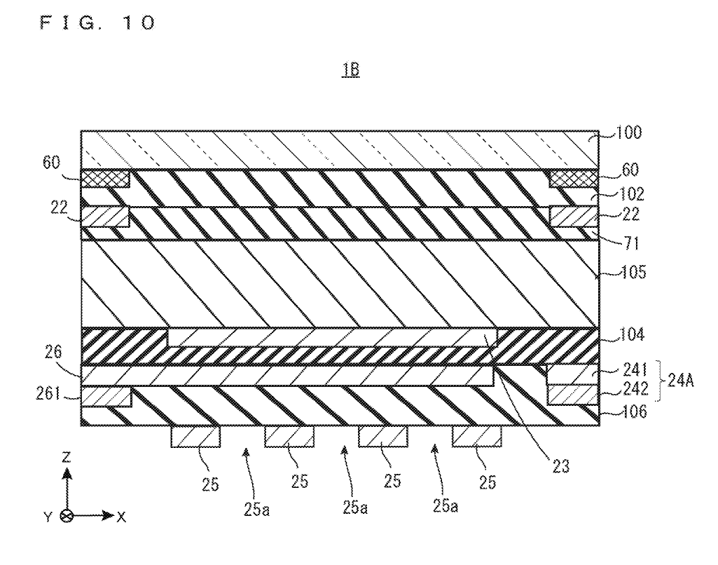

FIG. 9A is a cross-sectional view of a non-TFT area of an active matrix substrate in the present embodiment. FIG. 9B is a cross-sectional view of a counter substrate in the present embodiment. In FIGS. 9A and 9B, members identical to those in Embodiment 1 are denoted by the same reference symbols as those in Embodiment 1. The following description describes configurations different from those in Embodiment 1.

As illustrated in FIG. 9A, in the active matrix substrate 1A in the present embodiment, the color filter is provided so as not to be in contact with the first insulating film 102. On the other hand, in a counter substrate 2A of the present embodiment, as illustrated in FIG. 9B, a color filter 103 is provided between an overcoat layer 201 and a glass substrate 200. In other words, the present embodiment is different from Embodiment 1 in the point that the color filter 103 is provided on the counter substrate 2A. Incidentally, the overcoat layer 201 is provided so as to flatten steps between portions of the color filter 103 corresponding to different colors; it however can be omitted.

As illustrated in FIG. 9A, the first insulating film 102, the gate insulating film 71, and the organic insulating film 105 are provided between the glass substrate 100 and the touch detection electrode 23, and the second insulating film 104 is provided between the touch detection electrode 23 and the common electrode 26. In other words, in the present embodiment, the touch detection electrode 23 is provided at a position closer to the common electrode 26, as compared with Embodiment 1. Besides, the signal line 24 is provided in the same layer as that of the touch detection electrode 23.

In this example, the signal line 24 may be formed with, for example, a laminate film obtained by arranging a transparent electrode film made of the same material as that of the touch detection electrode 23 in contact with the organic insulating film 105, and arranging a metal film so that it overlaps with the transparent electrode film. This makes it possible to improve the adhesiveness between the organic insulating film 105 and signal line 24, as compared with a case where a signal line formed with a metal film is arranged on the organic insulating film 105.

In this way, by providing the touch detection electrode 23 at a position closer to the common electrode 26, the position of the touch detection electrode 23 is farther from a user, as compared with Embodiment 1. In Embodiment 2, therefore, the detection accuracy cannot be improved as compared with Embodiment 1. However, the same effects as those in Embodiment 1 except for this point can be achieved in Embodiment 2, too. More specifically, in the active matrix substrate 1A, as the touch detection electrode 23 and the common electrode 26 are provided independently from each other, the potential of the common electrode 26 does not change due to differences in the time constants of the signal lines 24, and display defects would not occur. Further, since the charging time and the detection time can be provided simultaneously in one vertical period, decreases in the brightness or decreases in the detection sensitivity can be reduced. Still further, in Embodiment 2 as well, as is the case with Embodiment 1, the shield electrodes are provided only on the counter substrate 2A. This makes it possible to suppress decreases in the detection accuracy, as compared with a case where the shield electrodes are provided on the substrate on the side where a user's finger touches.

Further, in the active matrix substrate 1A, since the touch detection electrode 23 and the pixel electrode 25 are arranged so as to overlap with each other (see FIG. 9A), the display area and the detection area overlap with each other, which allows the aperture ratio to be improved, as compared with a case where the detection area is provided separately from the display area.

Still further, in the active matrix substrate 1A, the touch detection electrode 23 and the signal line 24 are formed in the same layer. In a case where, as in Embodiment 1, the touch detection electrode 23 and the signal line 24 are formed in different layers, respectively, it is necessary to form a contact hole to connect the touch detection electrode 23 and the signal line 24; in Embodiment 2, however, since they are formed in the same layer, there is no need to form a contact hole. This makes it possible to omit a step of forming a contact hole for connecting the touch detection electrode 23 and the signal line 24. Besides, touch detection defects that would be caused in the contact hole by contact defects and the like between the touch detection electrode 23 and the signal line 24 can be reduced.

Still further, in Embodiment 2, the color filter 103 is provided in the counter substrate 2A. As compared with a case where the color filter 103 is provided in the active matrix substrate 1A, therefore, the steps for producing active matrix substrate 1A can be reduced.

Incidentally, in Embodiment 2 as well, the TFT 70 having the top gate structure is provided in each pixel, as is the case with Embodiment 1. It is therefore unnecessary to additionally provide a light-shielding film for blocking light from the backlight 5 (see FIG. 1) in the channel area of the TFT 70.

### (Other Configuration Examples)

The active matrix substrate 1A in Embodiment 2 is described above with reference to an exemplary configuration in which the touch detection electrode 23 and the signal line 24 are formed in the same layer, but as illustrated in FIG. 10, the signal line 24A may be formed in the same layer as that of the common electrode 26.

In this case, the signal line 24A is formed with a laminate film obtained by laminating a transparent electrode film 241 made of the same material as that of the common electrode 26, and a metal film 242.

At least one signal line 24A is connected to one touch detection electrode 23. At a position at which the touch detection electrode 23 and the signal line 24A are connected, therefore, a contact hole passing through the second insulating film 104 is provided, and the touch detection electrode 23 and the signal line 24A are connected through the contact hole.

Besides, since at least one signal line 24A may be connected to one touch detection electrode 23, there are some pixels in which no signal line 24A is arranged. In such a pixel, as illustrated in FIG. 10, a common electrode line 261 connected with the common electrode 26 is arranged. The common electrode line 261 is a line for supplying a voltage signal to the common electrode 26. The common electrode line 261 is formed with a metal film made of the same material as that of the metal film 242 of the signal line 24A. This allows the common electrode line 261 to be formed together with the signal line 24A, and this makes it possible to reduce the resistance of the common electrode 26, without adding a step of forming the common electrode line 261.

### Embodiment 3

Embodiment 1 is described above with reference to an example in which the color filter 103 is provided on the active matrix substrate 1, and the TFTs 70 having the top gate structure are provided on the active matrix substrate 1. As the present embodiment, an example is described in which the color filter 103 is arranged in the counter substrate, and the TFTs having a bottom gate structure are arranged in the active matrix substrate.

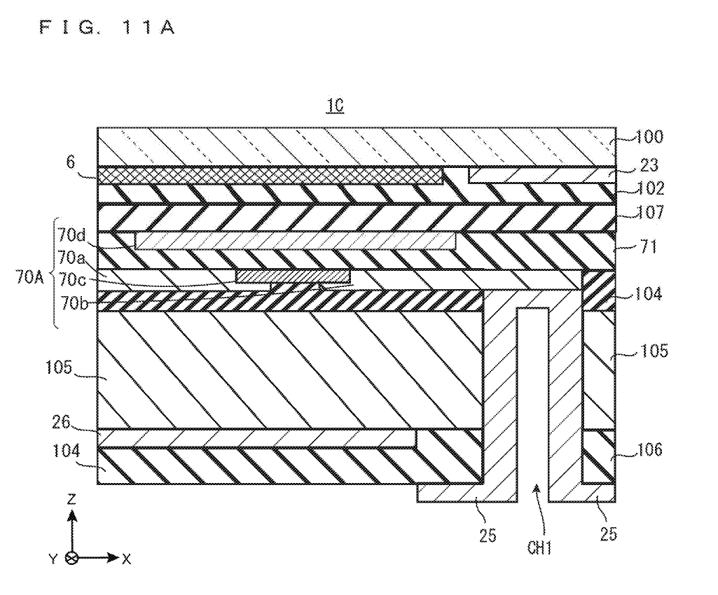

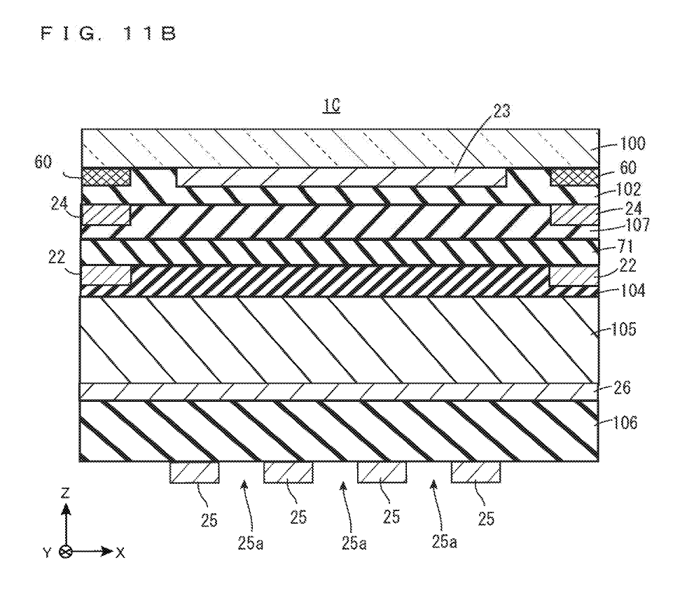

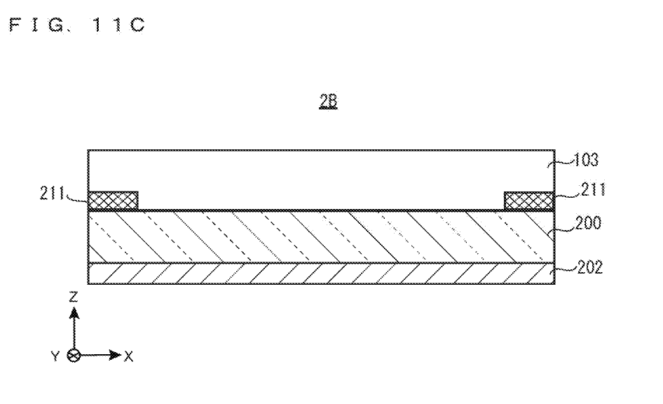

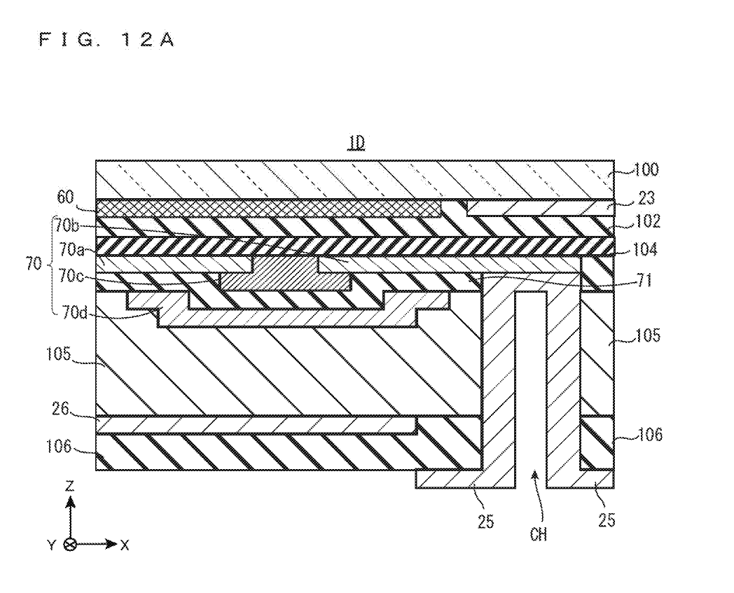

FIG. 11A is a cross-sectional view of a TFT area on an active matrix substrate in the present embodiment. FIG. 11B is a cross-sectional view of a non-TFT area on the active matrix substrate in the present embodiment. In FIGS. 11A and 11B, members identical to those in Embodiment 1 are denoted by the same reference symbols as those in Embodiment 1. The following description principally describes configurations different from those in Embodiment 1.

As illustrated in FIGS. 11A, 11B, in the active matrix substrate 1C in the present embodiment, the inorganic insulating film 107 is provided in place of the color filter 103, on the first insulating film 102. The inorganic insulating film 107 covers the first insulating film 102 in the TFT area, and covers the signal line 24 and the first insulating film 102 in the non-TFT area.

As illustrated in FIG. 11A, the gate electrode 70d of the TFT 70A in the present embodiment is provided in contact with the inorganic insulating film 107.

As illustrated in FIGS. 11A and 11B, the gate insulating film 71 covers the gate electrode 70d in the TFT area, and covers the inorganic insulating film 107 in the non-TFT area.

As illustrated in FIG. 11A, the source electrode 70a and the drain electrode 70b of the TFT 70A are provided in contact with the, gate insulating film 71. As illustrated in FIG. 11B, the data line 22 is provided in contact with the gate insulating film 71.

As illustrated in FIG. 11A, the semiconductor film 70c of the TFT 70A is provided on the gate insulating film 71. The source electrode 70a and the drain electrode 70b are formed on the gate insulating film 71 so as to overlap with a part of the semiconductor film 70c.

As illustrated in FIGS. 11A and 11B, the second insulating film 104 is provided on the gate insulating film 71, covers the source electrode 70a, the drain electrode 70b, and the semiconductor film 70c in the TFT area, and covers the data line 22 in the non-TFT area.

As illustrated in FIG. 11A, a contact hole CH1 passing through the second insulating film 104, the organic insulating film 105, and the third insulating film 106 is provided, and the pixel electrode 25 is connected with the drain electrode 70b of the TFT 70A through the contact hole CH1.

FIG. 11C is a cross-sectional view of the counter substrate in the present embodiment. In FIG. 11C, members identical to those in Embodiment 1 are denoted by the same reference symbols as those in Embodiment 1.

As illustrated in FIG. 11C, the counter substrate 2B in the present embodiment, a black matrix 211 is provided on a liquid crystal layer 3 side surface of the glass substrate 200. Further, the color filter 103 is provided so as to cover the black matrix 211. The black matrix 211 is provided in portions where it is required so as to block light from the backlight 5 to a channel area of the TFT 70A. Incidentally, an overcoat layer 201 identical to that in Embodiment 2 may be provided on the color filter 103.

In the active matrix substrate 1C in the present embodiment, the black matrix 60 is provided, but the black matrix 60 is not an imperative member. In the present embodiment, the TFT 70A has a bottom gate structure in which the gate electrode 70d is provided on the glass substrate 100 side with respect to the semiconductor film 70c. With this configuration, external light incident from the glass substrate 100 onto a channel area of the TFT 70A is blocked by the gate electrode 70d. In other words, the gate electrode 70d functions as a light-shielding film. In the active matrix substrate 1C, therefore, the black matrix 60 is not necessarily provided. Incidentally, in a case where the black matrix 60 is not provided on the active matrix substrate 1C, for example, cover glass provided with a light-shielding film may be provided on a surface that a user touches, in order to prevent reflection of external light (glare) in the frame region.

In Embodiment 3 described above, since the TFT 70A has the bottom gate structure, the black matrix 211 for blocking backlight light is required in the counter substrate 2B. However, the same effects as those in Embodiment 1 except for this point can be achieved in Embodiment 3, too. More specifically, in Embodiment 3 as well, as the common electrode 26 and the touch detection electrode 23 are provided independently from each other, the potential of the common electrode 26 does not change due to differences in the time constants of the signal lines 24, and display defects would not occur. Further, since the charging time and the detection time can be provided simultaneously in one vertical period, decreases in the brightness or decreases in the detection sensitivity can be reduced.

Still further, the shield electrodes 202 (see FIG. 11C) are provided only on the counter substrate 2B. This makes it possible to reduce decreases in the detection accuracy, as compared with a case where the shield electrodes are provided on the substrate on the side where a user's finger touches. Besides, in the active matrix substrate 1C, since the touch detection electrode 23 and the pixel electrode 25 are arranged so as to overlap with each other (see FIGS. 11A, 11B), the display area and the detection area overlap with each other, which allows the aperture ratio to be improved, as compared with a case where the detection area is provided separately from the display area.

Exemplary touch-panel-equipped display devices according to the present invention are described above, but the configuration of the touch-panel-equipped display device according to the present invention is not limited to the configurations of the embodiments described above, but may be any one of a variety of modified configurations. The following description describes the modification examples.

### Modification Example 1

Embodiment 2 is described above with reference to an example in which the color filter is provided in the counter substrate, but the color filter may be provided so as to be in contact with the first insulating film 102 in the active matrix substrate 1A, as is the case with Embodiment 1.

### Modification Example 2

A touch-panel-equipped display device may be formed by combining the counter substrate 2A in Embodiment 2 and the active matrix substrate 1 in Embodiment 1.

### Modification Example 3

In the embodiments and the modification examples, the semiconductor film 70c is not limited to an oxide semiconductor film, but may be an amorphous silicon film.

### Modification Example 4

The foregoing embodiments and modification examples are described with reference to an example in which the touch-panel-equipped display device includes the active matrix substrate, the counter substrate, the liquid crystal layer, the polarizing plates, and the backlight, but the touch-panel-equipped display device is required to include only the active matrix substrate, the counter substrate, and the liquid crystal layer.

### Modification Example 5

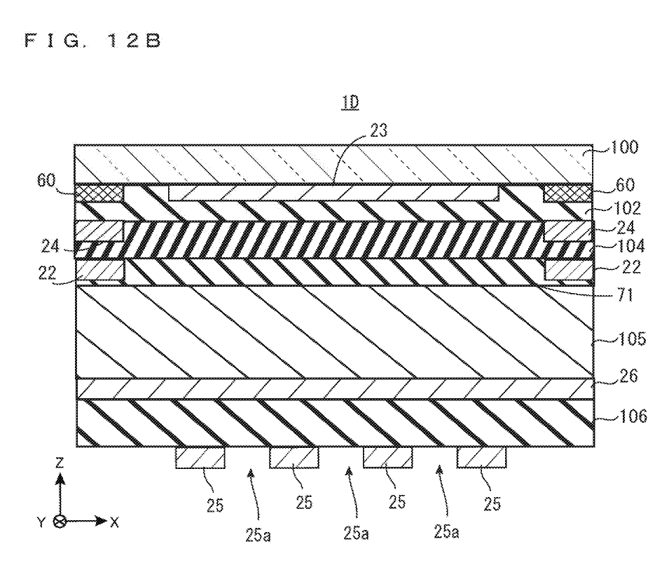

In Embodiment 1 described above, the color filter 103 is provided in the active matrix substrate 1, but the color filter 103 may be provided in the counter substrate 2, as is the case with Embodiment 2. In other words, the active matrix substrate 1D in the present modification example is not provided with the color filter 103 in the TFT area and the non-TFT area, as illustrated in FIGS. 12A and 128.

### Modification Example 6

As the TFT in Embodiment 1 and Embodiment 2 described above, an exemplary TFT is described that has the top gate structure in which the gate electrode 70d is arranged on the liquid crystal layer 3 side with respect to the semiconductor film 70c. The TFT, however, may have the bottom gate structure in which the gate electrode 70d is provided on the glass substrate 100 side with respect to the semiconductor film 70c, as is the case with Embodiment 3.

1. A touch-panel-equipped display device comprising an active matrix substrate, a counter substrate provided so as to be opposed to the active matrix substrate, and a liquid crystal layer provided between the active matrix substrate and the counter substrate, the touch-panel-equipped display device having a touch surface on a side of the active matrix substrate,
wherein the active matrix substrate includes:
a substrate;
a plurality of pixel electrodes;
a common electrode;
a plurality of touch detection electrodes for detecting touch with respect to the touch surface; and
a plurality of signal lines connected with the touch detection electrodes, respectively,
the pixel electrodes, the common electrode, the touch detection electrodes, and the signal lines being provided on the liquid crystal layer side of the substrate,
wherein the pixel electrodes, the common electrode, and the touch detection electrodes are arranged so as to overlap with one another when viewed in a plan view, and the touch detection electrodes are provided at positions closer to the substrate, as compared with the pixel electrodes and the common electrode.

2. The touch-panel-equipped display device according to claim 1,
wherein the active matrix substrate further includes a light-shielding part between the pixel electrodes and the substrate.

3. The touch-panel-equipped display device according to claim 2,
wherein the light-shielding part is made of a resin in black color.

4. The touch-panel-equipped display device according to claim 2,
wherein the light-shielding part is provided at a position that does not overlap with the pixel electrodes.

5. The touch-panel-equipped display device according to claim 2,
wherein the light-shielding part is provided at a position that does not overlap with the touch detection electrodes.

6. The touch-panel-equipped display device according to claim 1,
wherein the active matrix substrate further includes a color filter that is provided at a position overlapping with the pixel electrodes.

7. The touch-panel-equipped display device according to claim 1,
wherein the counter substrate further includes a color filter that is provided at a position overlapping with the pixel electrodes.

8. The touch-panel-equipped display device according to claim 1,
wherein the touch detection electrodes are arranged so as to be in contact with the substrate,
the active matrix substrate further includes at least one insulating film between the touch detection electrodes and the common electrode, and at least one insulating film between the common electrode and the pixel electrodes.

9. The touch-panel-equipped display device according to claim 1,
wherein the active matrix substrate further includes a plurality of gate lines, and a plurality of data lines, and
the touch detection electrodes are provided at positions closer to the substrate, as compared with the gate lines and the data lines.

10. The touch-panel-equipped display device according to claim 1,
wherein the signal lines and the touch detection electrodes are provided in different layers.

11. The touch-panel-equipped display device according to claim 1,
wherein the signal lines and the touch detection electrodes are provided in the same layer,
the active matrix substrate further includes at least one insulating film between the substrate and the touch detection electrodes, at least one insulating film between the touch detection electrodes and the common electrode, and at least one insulating film between the common electrode and the pixel electrodes.

12. The touch-panel-equipped display device according to claim 1,
wherein the active matrix substrate further includes a plurality of switching elements each of which includes a source electrode, a drain electrode, a semiconductor film, and a gate electrode, and
the gate electrode is provided on a side of the liquid crystal layer, with respect to the semiconductor film.

13. The touch-panel-equipped display device according to claim 1,
wherein the active matrix substrate further includes a plurality of switching elements each of which includes a source electrode, a drain electrode, a semiconductor film, and a gate electrode, and
the gate electrode is provided on a side of the substrate, with respect to the semiconductor film.

14. The touch-panel-equipped display device according to claim 1,
wherein the counter substrate further includes a transparent electrode layer on a surface of the counter substrate on a side opposite to the liquid crystal layer so that the transparent electrode layer overlaps with the pixel electrodes.
